(19) United States
(12) Patent Application Publication
(10) Pub. No.: US 2017/0120796 A1
(43) Pub. Date: May 4, 2017

(54) Novel Frac Tank and Trailer Assembly

(71) Applicant: Michael Scott, Cheyenne, WY (US)

(72) Inventor: Michael Scott, Cheyenne, WY (US)

(21) Appl. No.: 14/926,762

(22) Filed: Oct. 29, 2015

(51) Int. Cl. B60P 3/22

(52) U.S. Cl. CPC B60P 3/2215; E21B 43/26

(57) ABSTRACT

An improved fracking tank comprising a tank assembly comprising a first section and a fluidly attached second section, where the lower surface of the floor of the second section is higher than the lower surface of the floor of the first section, and where said tank assembly has a fluid holding capacity in the range of 8,400 gallons to 30,000 gallons, also comprising a trailer assembly detachably attached to said tank assembly comprising a first portion with a first surface supporting the tank first section and also comprising a plurality of axles, and a second portion with a second surface supporting the tank assembly second section, and further comprising a hitch portion.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND

This invention relates generally to a novel portable fluid container for use in fracking operations.

Frac tanks are known to the art for use in oil fields, (also known as “fracking sites” or “fracking fields”) for providing fluids to oil wells, for storage of fluids, or for deposit of waste fluids other than oil coining out of the well. Frac tanks may be used to store a variety of fluids such as water, salt water, acids from drilling muds, and the like.

Frac tanks known to the art are typically cylindrical or rectangular, made of steel and, configured to be pulled by a conventional tractor, diesel, semi-thick or other suitable vehicle. Many steel frac tanks have a single rude with multiple wheels at one end, and have a hitch or connection at the other end to couple to a tractor. In this way, the tractor can pull the frac tank to and from the oil field. Due to the immense amounts of fluid used and also generated in fracking, a site near, or in the oil field is typically designated to store a number of frac tanks, it is necessary to frequently take frac tanks to and from the oil field to the road to be emptied into road-going tankers or offsite disposal.

One shortcoming of frac tanks known to the an is the relatively small amount of fluid each frac tank holds, relative to the vast quantities of fluid required for fracking. Frac tanks known to the art generally hold less than 10,000 gallons of fluid, necessitating a large number of frac tanks being delivered to and from the oil field on a continuous basis.

Another shortcoming of frac tanks known to the art is their lack of suitability for both over-the-road and off-road travel, both of which are necessary. Frac tanks known to the art are poorly suited for either off-road or over-the-road travel at highway speeds. Further, frac tanks known to the art are generally incapable of off-road or over the road travel at highway speeds when full.

### SUMMARY

The present invention is directed to an improved frac tank capable of storing greater amounts of fluid than frac tanks known to the art, while also being capable of connection to a tractor or a truck for off-road travel or for travel over-the-road at highway speeds, and capable of travel off-road or over-the-road at highway speeds when full.

Generally, embodiments of the present invention comprise a combination tank and trailer. In embodiments of the present invention, the tank assembly comprises a first section comprising walls, a floor, and a ceiling and a second section in fluid communication with said first section comprising walls, a floor, and a ceiling, and wherein the lower surface of the floor of said second section is higher than the lower surface of the floor of said first section, and wherein said tank assembly has a fluid holding capacity in the range of 8,400 gallons to 30,000 gallons. In embodiments of the present invention, the trailer assembly is detachably attached to the tank and comprises a first portion, said first portion comprising a first surface located at a height to support said tank assembly first section and said first portion further comprising a plurality of axles, wherein each axle is operatively connected at a first end to at least a first a wheel and is operatively connected at a second end to at least a second wheel, and a second portion, said second portion comprising a second surface located at a height to support said tank assembly second section, said second portion thriller comprising a hitch portion.

### BRIEF DESCRIPTION OF THE DRAWINGS

These and other features, aspects, and advantages of the present invention will become better understood with regard to the following description and accompanying drawings, where:

FIG. 1 shows a perspective view of the tank and trailer assemblies of a preferred embodiment of the present invention:

FIG. 2 shows a left side view of the tank and trailer assemblies of a preferred embodiment of the present invention;

FIG. 3 shows a right side view of the tank and trailer assemblies of a preferred embodiment of the present invention;

FIG. 4 shows a rear view of the tank and trailer assemblies of a preferred embodiment of the present invention;

FIG. 5 shows a front view of the tank and trailer assemblies of a preferred embodiment of the present invention;

FIG. 6 shows a bottom view of the trailer assembly of a preferred embodiment of the present invention;

FIG. 7 shows a top view of the trailer assembly of a preferred embodiment oldie present invention;

FIG. 8 shows a left side view of the trailer assembly of a preferred embodiment of the present invention;

FIG. 9 shows a right side view of the trailer assembly of a preferred embodiment of the present invention; and

FIG. 10 shows a partial bottom view of a portion of the second section of the trailer of a preferred embodiment of the present invention; and

FIG. 11 shows a partial bottom view of a portion of the first section of the trailer of a preferred embodiment of the present invention.

### DETAILED DESCRIPTION

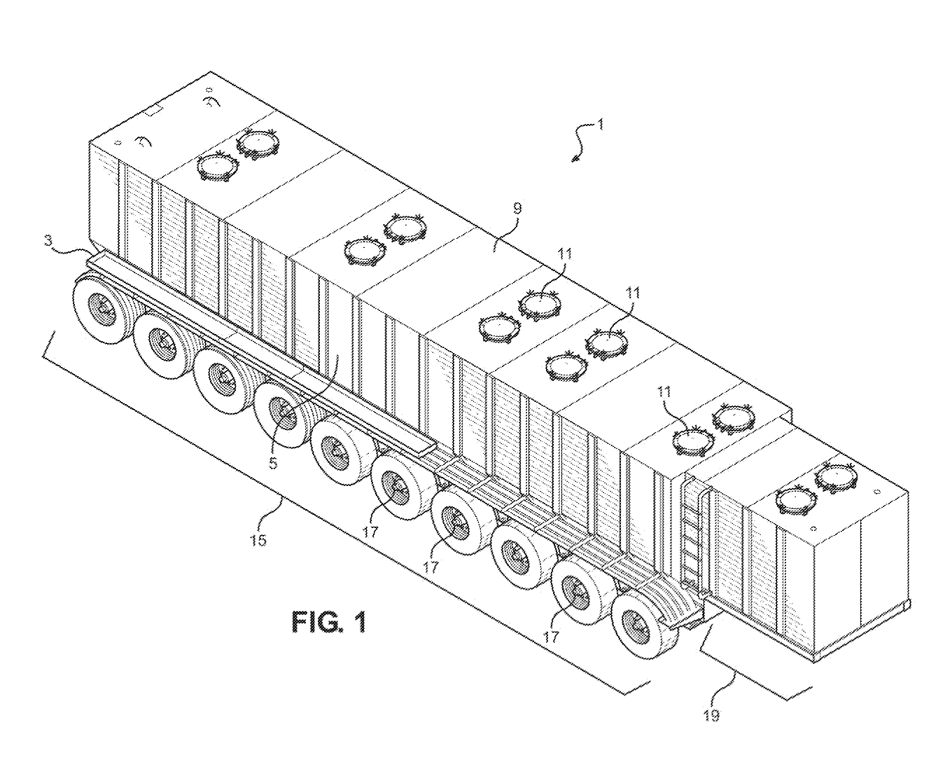

Referring now to the Figures, FIG. 1 show a preferred embodiment of the present invention.

A “tank assembly” (1) as taught herein is a container, preferably constructed of multiple panels or pieces, that is substantially watertight and is suitable to be carried on a trailer assembly (3) as taught herein. A tank assembly (1) according to teachings of the present invention may be made of any material suitable to withstand the rigors of containing large amounts of fluid for storage and of withstanding the plurality of stresses that occur when transporting a large amount of fluid over the road or off-road. Preferable materials include plastics, fiberglass, metals, and metal alloys, including most preferably high-strength stainless steel. A tank assembly (1) as taught herein may be of any shape that accommodates these purposes. In a preferred embodiment, as shown in FIG. 1, the tank assembly (1) is composed of multiple panels to make a generally rectangular structure.

In a preferred embodiment, a tank assembly (1) is made of metal panels that are joined to create a substantially flat floor (7) suitable tor resting on a trailer assembly (3) as taught herein, substantially flat walls (5) suitable to contain fluid, and a substantially flat ceiling (9). Each of the floor (7), ceiling (9), and each all (5) may be a single unified structure, or may each be made of a single panel, or, in the preferred embodiment disclosed in the Figures, each of the floor (7), ceiling (9), and each wall (5) are made of multiple panels joined to each other. In these embodiments, panels forming the tank assembly (1) may be joined to each other by any method that results in a substantially watertight interface between panels, to render the resulting container suitable for the transport of fluids. In a preferred embodiment, panels are welded to each other to form substantially watertight connections. In this preferred embodiment, wall panels that join to the panels comprising the floor or the ceiling are joined to those floor or ceiling panels through bevel welds, as would be appreciated by one skilled in the art. Alternatively, a tank assembly (1) may be made of a non-metallic material such as a plastic, resin, or fiberglass, and may be formed of a single piece, or may be formed in multiple pieces that are welded, mechanically connected, or bonded adhesively, as would be appreciated by one skilled in the art. A tank assembly (1) as taught herein can hold large amounts of fluid. In preferred embodiments, the tank assembly (1) has as maximum internal fluid capacity of more than 8400 gallons, more preferably more than 15,000 gallons, still more preferably more than 20,000 gallons, and most preferably more than 25,000 gallons. In the embodiments depicted in the Figures, the tank assembly (1) has a maximum internal fluid capacity of 25,200 gallons.

The tank assembly (1) further comprises at least one, and preferably a plurality, of access openings (11) to allow water to be pumped into and out of the tank assembly (1). While the access opening (11) may be located virtually an where through the surface of the tank assembly, there are preferably a plurality of access openings (11), and these plurality of access openings (11) are most preferably located in the ceiling, as shown in FIG. 1. An access opening (11) is preferably covered, and the cover is preferably hinged and is also preferably locked or lockable. The access opening (11) can be of virtually any shape or size suitable to the overall size of the tank assembly (1). In the preferred embodiment shown in FIG. 1, each access opening (11) is shaped to couple, or most preferably disengagably lock, to a hose or tube for filling or emptying of the tank assembly (1). While the tank assembly (1) is substantially watertight, it is not necessary for the tank assembly (1) as a whole to hold as vacuum with access openings (11) in an either open or closed position. In a preferred embodiment, the tank assembly (1) is filled or emptied by use of one or more hydraulic pumps (13). Such hydraulic pumps (13) may be pieces of equipment separate from the frac tank of the present invention, or, preferably, may be mounted or connected to a frac tank of the present invention. Through the use of hydraulic pumps (13), fluid may be transported into or out of the frac tank to locations more distant from the frac tank than are possible for prior art frac tanks, particularly those that operate under an internal vacuum.

A tank assembly (1) herein comprises in part a first section (15). In a preferred embodiment, the first section (15) is that portion of the tank assembly (1) configured to rest substantially over the axles (17) of the trailer assembly (3). In a preferred embodiment, the first section (15) comprises a floor, walls, and a ceiling, the ceiling comprising a plurality of access openings (11).

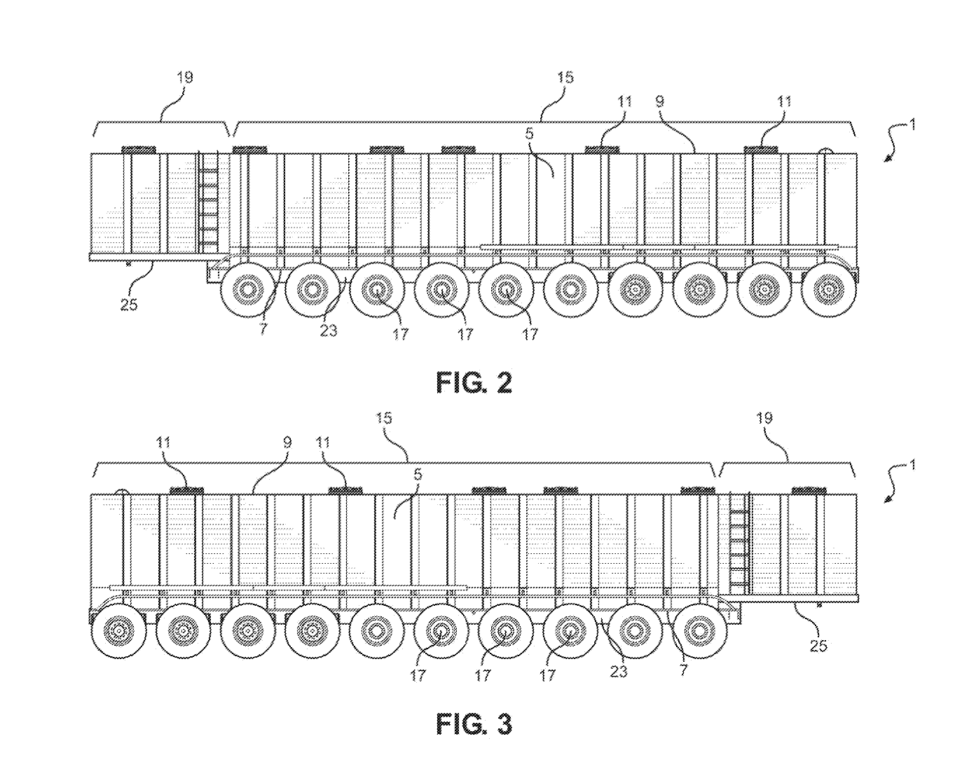

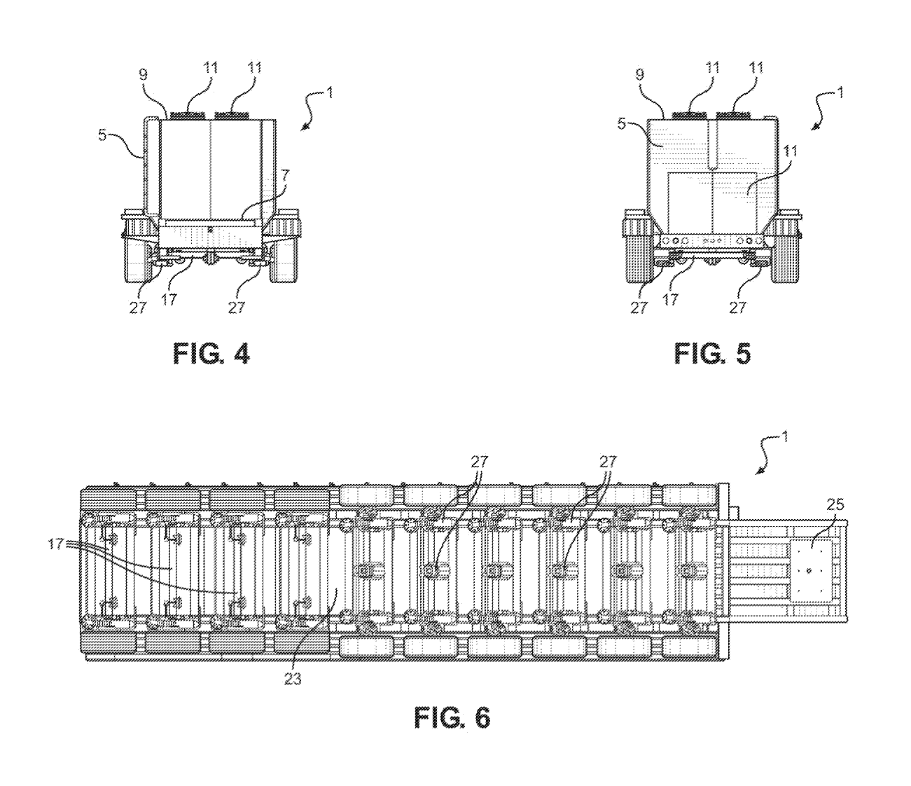

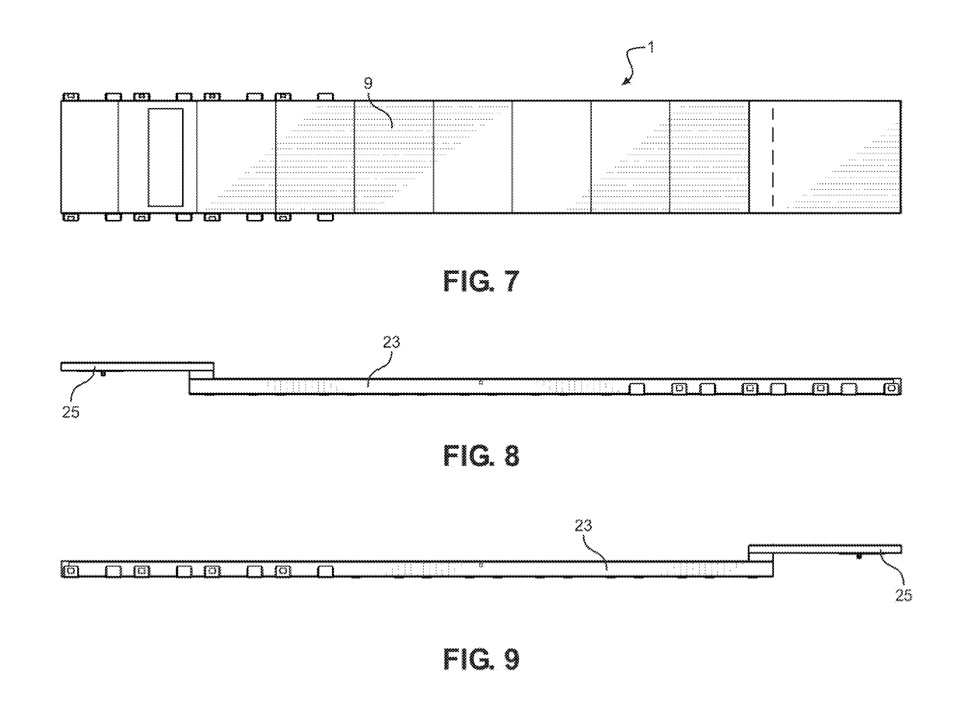

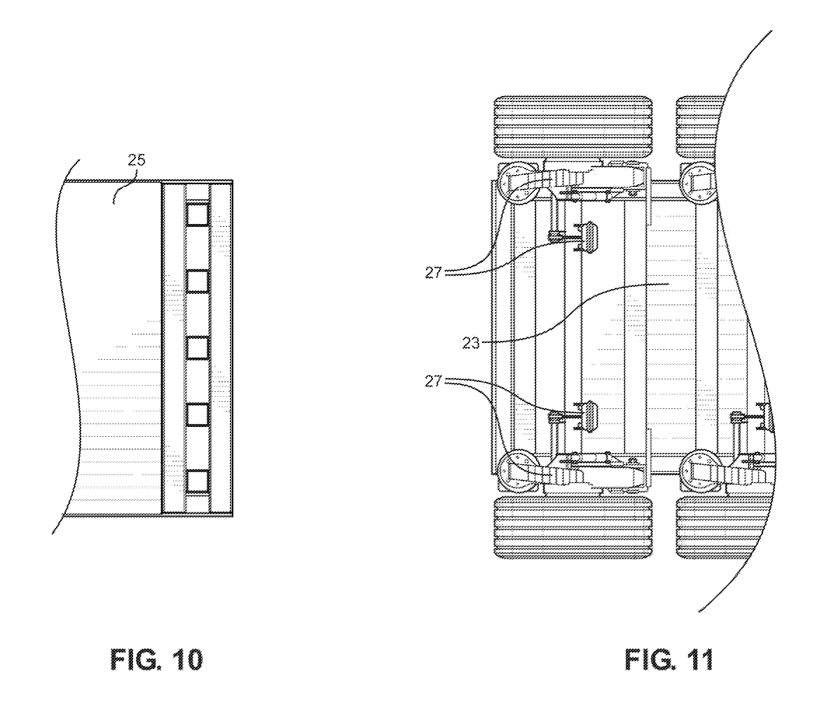

The tank assembly (1) herein further comprises a second section (19) in internal fluid connection with the first section (15). The second section (19) is that portion of the tank assembly (1) configured to rest substantially over the hitch portion (21) of the trailer assembly (3). The second section (19) is preferably smaller than the first section (1) in at least one external dimension. In as preferred embodiment, as shown in FIGS. 2 and 3, the second section (19) is smaller than the first section (1) in the dimensions of width and height, such that the first section (1) and second section (19) have coplanar ceiling portions, but do not have coplanar wall or floor portions. The second section (19) may, in the preferred embodiments, be made of additional panels attached, preferably by welding, to each other and to the panels of the first section (1) to form the tank assembly (1) container section of the desired shape. In other embodiments, the second section (19) may be formed integrally with all or portion of the first section (1). The second section (19) preferably comprises at least one access opening (11), and most preferably comprises as plurality of access openings (11). Although the at least one access opening (11) may be located in any suitable location on the second section, the preferred access opening (11) location is the second section (19) ceiling.

The present invention further includes a trailer assembly (3) detachably attached to the tank assembly (1). A trailer assembly (3) as disclosed herein generally comprises a large platform with a top surface configured support the tank assembly (1), a bottom surface operatively connected to a plurality of axles (17), each of said axles (17) operatively connected at or near each end to one or more wheels, each of said wheels operatively connected to at least one suspension element (27), and a hitch portion (21) disposed at or near one end of the trailer assembly (3) comprising a mechanical connecting device for connection to a truck, tractor, or other vehicle.

The trailer assembly (3) is made of a material, and in general configuration, suitable for hauling heavy loads by truck or tractor over-the-road and off-road. Preferably,

The trailer assembly (3) is detachably attached to the tank assembly (1). The trailer assembly (3) and tank assembly (1) may be detachably attached by straps, chains, interlocking parts, or other mechanical connections suitable to retain heavy loads during, transit, as would be apparent to one skilled in the art. In the preferred embodiment depicted herein, as shown in FIGS. 8 and 9, the trailer assembly (3) comprises to first portion (23) that comprises a substantially flat horizontal surface configured to support the tank assembly first section (15) and further comprises one or more studs or protrusions configured to assist with detachable attachment of the tank assembly (1). This preferred embodiment further comprises a second portion (25) attached to the first portion (23), comprising a flat horizontal surface with an area smaller than the area defined by flat horizontal surface of the first portion (23), configured to support the tank assembly second section (19) and located higher from the ground than the first portion (23). Thus each of the tank assembly first section (15) and tank assembly second section (19) are substantially fully supported by a portion of the trailer assembly (3). The trailer assembly second portion (25) is further attached to a hitch portion (21).

The trailer assembly (3) further comprises a plurality of axles (17) operatively connected to the bottom surface of the first portion (23). As would be appreciated by one skilled in the art, an axle (17) can be operatively connected to the bottom surface of a trailer portion through a variety of known intermediary mechanical connections or fittings that permit desired rotation of the axle (17) while retaining the axle (17) firmly, including, by way of example, brackets, tabs, and holders, or, optionally, by operative connection to one or more wheels that are operatively connected to the trailer assembly (3). Each of the plurality of axles (17) may constitute a one-piece axle or a split axle. To accommodate the weight of a full tank assembly (1) during over-the-road or off-road transit, the trailer assembly (3) of the present invention makes use of a plurality of axles (17), preferably eight or more. In a most preferred embodiment, as shown in FIG. 6, the trailer assembly (3) comprises ten axles (17) operatively connected to the trailer assembly (3).

Each of the plurality of axles (17) is operatively connected at each end to at least one wheel. As would be understood by one skilled in the art, an axle (17) can be operatively connected to a wheel directly, or through a variety of intermediary connections or fittings that enable sympathetic rotation of the wheel and axle, including, by way of example, ball or CV joints. In a preferred embodiment herein, at least some of the plurality of axles (17) comprise, a split axle permitting the wheel operatively connected to one end of the axle to engage in rotation, and movement other than rotation, independent of the wheel operatively connected to the other end of the axle.

Each of said wheels is operatively connected to at least one suspension element (27). As would be appreciated by one skilled in the art, virtually any suspension element (27) suitable for use in connection with a semi-truck trailer may be used within the scope and spirit of this invention. Suitable suspension elements (27) include, by way of non-limiting example, leaf springs, coil springs, air springs, hydraulic shock absorbers, pneumatic shock absorbers, and magnetic shock absorbers. Each wheel may be operatively connected to one or multiple suspension elements (27). In a preferred embodiment, each wheel is connected to both a primary and second suspension element (27). Optionally, each of the plurality of axles (17) may be operatively connected to the same, or to different suspension elements (27) as are operatively connected to the wheels.

The trailer assembly (3) further comprises on a hitch portion (21) attached to said second portion (25). The hitch portion (21) can comprise any mechanical hitch known to the art for connection of an over-the-road or off-road trailer to a semi-truck, pickup truck, or tractor. A hitch portion (21) may comprise, by way of non-limiting example, a socket hitch, a fifth wheel hitch, a gooseneck hitch, or a kingpin hitch. The hitch portion (21) is rigidly attached to the second portion (25). In a preferred embodiment, the hitch portion (21) is a kingpin hitch integral to the bottom surface of said second portion.

In use, the frac tank of the present invention can be relatively quickly and conveniently hitched to a truck for over-the-road transport, can be hauled over the road safely at highway speeds, can be relatively quickly and conveniently transferred to a tractor for off-road transport to or from an oil field site, and can be hauled over uneven ground safely at normal off-road transport speeds. Further, the frac tank of the present invention can safely perform each of these tasks when empty, when partially full, or when completely full. The frac tank of the present invention can further receive substantially greater volumes of fluid than frac tanks known the art.

Although the present invention has been described in considerable detail with reference to certain preferred versions thereof other versions are possible. For example, materials, shapes, sizes, or configurations other than those described in detail herein may be used for the versions of this invention. Therefore, the spirit and scope of the claims should not be limited to the description of the preferred versions described herein.

What is claimed is:

1. A frac tank assembly, said assembly comprising:
a tank assembly comprising a first section comprising walls, a floor, and a ceiling and a second section in fluid communication with said first section comprising walls, a floor, and a ceiling, and wherein the lower surface of the floor of said second section is higher than the lower surface of the floor of said first section, and wherein said tank assembly has a fluid holding capacity in the range of 8,400 gallons to 30,000 gallons;
a trailer assembly detachably attached to said tank assembly, said trailer assembly comprising a first portion, said first portion comprising a first surface located at a height to support said tank assembly first section and said first portion further comprising a plurality of axles, wherein each axle is operatively connected at a first end to at least a first a wheel and is operatively connected at a second end to at least a second wheel;
said trailer assembly further comprising a second portion, said second portion comprising a second surface located at a height to support said tank assembly second section said second portion further comprising a hitch portion.

2. The frac tank assembly of claim 1, wherein said plurality of axles comprises at least ten axles.

3. The frac tank assembly of claim 2, wherein each of said first wheels and each of said second wheels is operatively connected to at least one suspension element.

4. The frac tank assembly of claim 3, wherein each said suspension element is independent of every other said suspension element.

5. The frac tank assembly of claim 4, wherein at least one of said at plurality of access openings is configured to couple to a hose.

6. The frac tank assembly of claim 5, wherein said second section ceiling further comprises at least one access opening.

7. A frac tank assembly, said assembly comprising:
a tank assembly comprising a first section comprising walls, a floor, and a ceiling and a second section in fluid communication with said first section comprising walls, a floor, and a ceiling, and wherein the lower surface of the floor of said second section is higher than the lower surface attic floor of said first section, and wherein said tank assembly has a fluid holding capacity in the range of 15,000 gallons to 30,000 gallons;
a trailer assembly detachably attached to said tank assembly, said trailer assembly comprising a first portion, said first portion comprising a first surface located at a height to support said tank assembly first section and said first portion further comprising a plurality of axles, wherein each axle is operatively connected at a first end to at least a first a wheel and is operatively connected at a second end to at least a second wheel;
said trailer assembly further comprising a second portion, said second portion comprising a second surface located at a height to support said tank assembly second section, said second portion further comprising a hitch portion.

8. The frac tank assembly of claim 7, wherein said plurality of axles comprises at least ten axles.

9. The frac tank assembly of claim 8, wherein each of said first wheels and each or said second wheels is operatively connected to at least one suspension element.

10. The frac tank assembly of claim 9, wherein each said suspension element is independent of every other said suspension element.

11. The frac tank assembly of claim 10, wherein at least one of said at plurality of access openings is configured to couple to a hose.

12. The frac tank assembly of claim 11, wherein said second section ceiling further comprises at least one access opening.

13. A frac tank assembly, said assembly comprising:
a tank assembly comprising a first section comprising walls, as floor, and a ceiling and a second section in fluid communication with said first section comprising walls, a floor, and a ceiling, and wherein the lower surface of the floor of said second section is higher than the lower surface of the floor of said first section, and wherein said tank assembly has a fluid holding capacity in the range of 22,000 gallons to 30,000 gallons;
a trailer assembly detachably attached to said tank assembly, said trailer assembly comprising a first portion, said first portion comprising as first surface located at a height to support said tank assembly first section and said first portion further comprising a plurality of axles, wherein each axle is operatively connected at a first end to at least a first a wheel and is operatively connected at a second end to at least a second wheel;
said trailer assembly further comprising a second portion, said second portion comprising a second surface located at a height to support said tank assembly second section, said second portion further comprising a hitch portion.

14. The frac tank assembly of claim 13, wherein said plurality of axles comprises at least ten axles.

15. The frac tank assembly of claim 14, wherein each of said first wheels and each of said second wheels is operatively connected to at least one suspension element.

16. The frac tank assembly of claim 15, wherein each said suspension element is independent of every other said suspension element.

17. The frac tank assembly of claim 16, wherein at least one of said at plurality of access openings is configured to couple to a hose.

18. The fine tank assembly of claim 17, wherein said second section ceiling further comprises at least one access opening.
